(19) United States
(12) Patent Application Publication
(10) Pub. No.: US 2017/0004435 A1
(43) Pub. Date: Jan. 5, 2017

(54) METHOD FOR PROVIDING TEAM-LEVEL METRICS DATA AND TEAM STATE MONITORING SYSTEM

(71) Applicant: THALES CANADA INC., Toronto (CA)

(72) Inventors: Jean-François GAGNON, Stoneham-et-Tewkesbury (CA); Daniel LAFOND, Quebec (CA); Martin RIVEST, Quebec (CA); François COUDERC, Quebec (CA); Stéphane DION, Quebec (CA)

(21) Appl. No.: 15/198,783

(22) Filed: Jun. 30, 2016

Related U.S. Application Data
(60) Provisional application No. 62/187,482, filed on Jul. 1, 2015.

(51) Int. Cl. G06Q 10/06

(52) U.S. Cl. CPC G06Q 10/06398

(57) ABSTRACT

A method and system are disclosed for providing team-level metrics data, the method comprising for each member of a team, collecting sensor data originating from a plurality of sensors, and locally processing the collected sensor data to provide data representative of an individual functional assessment; wirelessly obtaining each of the data representative of an individual functional assessment and processing each of the obtained data representative of an individual functional assessment to generate data representative of a functional state of the team.

### CROSS-REFERENCE TO RELATED APPLICATION

The present patent application claims priority on U.S. Provisional Patent Application No. 62/187,482, filed on Jul. 1, 2015, the subject matter of which is incorporated herein by reference.

### FIELD

The invention relates to data processing. More precisely, the invention pertains to a method for providing team-level metrics data and a team state monitoring system.

### BACKGROUND

Wearable sensor data has been used in prior-art solutions for performing a diagnostic of a user in real time.

Such diagnostic of a user is typically performed using a mobile device carried out by the user.

The mobile device will further serve as a bridge between the sensors and receivers.

Unfortunately, the outputs of the mobile device are generally limited to raw data that are provided to the delocalized servers or receivers.

In certain cases, team member metrics are derived, post facto, using an offline analysis of the raw data or data logs by the delocalized servers or receivers.

While this may be pertinent, such as in the case where a debriefing is performed, such solution suffers from serious limitations in the cases where decisions have to be made for a team in the course of a completion of a task.

In addition, such solution may be complicated to scale. More precisely, it may be difficult to dynamically add to or subtract members from a given team. It will also be cumbersome to increase additional sensors due to the traffic generated by the sensors when data is provided to the delocalized servers or receivers.

There is a need for at least one of system and a method that will overcome at least one of the above-identified drawbacks.

Features of the invention will be apparent from review of the disclosure, drawings and description of the invention below.

### BRIEF SUMMARY

According to a broad aspect, there is disclosed a method for providing team-level metrics data, the method comprising for each member of a team: collecting sensor data originating from a plurality of sensors, and locally processing the collected sensor data to provide data representative of an individual functional assessment; wirelessly obtaining each of the data representative of an individual functional assessment and processing each of the obtained data representative of an individual functional assessment to generate data representative of a team functional assessment.

According to one embodiment, the processing comprises providing the data representative of a team functional assessment to a visualization interface.

According to one embodiment, the providing of the data of a team functional assessment to a visualization interface comprises one of pushing and pulling the data of a team functional assessment to the visualization interface.

According to one embodiment, the collecting of the sensor data originating from a plurality of sensors comprises collecting data from a plurality of wearable sensors and connecting data from a plurality of non-wearable sensors.

According to one embodiment, the processing of the collected sensor data comprises filtering the collected sensor data, generating dimension data using at least the filtered collected sensor data and generating data representative of an individual functional assessment using the generated dimension data.

According to one embodiment, the filtering of the collected sensor data is performed using at least one of a Fast Fourier Transform procedure, moving average and Kalman filters.

According to one embodiment, the wirelessly obtaining of each of the data representative of an individual functional assessment comprises determining a team processing unit for performing the processing associated with the team and the team processing unit receiving each of the data representative of an individual functional assessment.

According to one embodiment, the team processing unit further receives sensor data from at least one other sensor, the processing of each of the obtained data representative of an individual functional assessment to generate data representative of a team functional assessment is also performed using the sensor data received from the at least one other sensor.

According to one embodiment, the method further comprises providing the data representative of a team functional assessment to a remote processing unit.

According to a broad aspect, there is disclosed a system for providing team-level metrics data of a team comprising a plurality of users, the system comprising a plurality of mobile processing units, the plurality of mobile processing units comprising at least one mobile individual processing unit, each carried out by a given user, each mobile individual processing unit receiving corresponding sensor data from a corresponding plurality of sensors, each mobile individual processing unit processing the corresponding sensor data and determining a corresponding individual functional assessment; and a mobile team processing unit operatively connected to the at least one mobile individual processing unit, the mobile team processing unit receiving each of the at least one corresponding individual functional assessment and processing the at least one corresponding individual functional assessment to generate data representative of a team functional assessment.

In accordance with one embodiment, the mobile team processing unit is carried out by a given user of the team, further wherein the mobile team processing unit receives sensor data from a plurality of sensors operatively connected to the mobile team processing unit and processes the sensor data to determine an individual functional assessment for the given user; further wherein the generating of the data representative of a team functional assessment is performed using also the individual functional assessment for the given user.

In accordance with one embodiment, the plurality of mobile processing units are selected from a group consisting of smartphones, tablet PCs and dedicated portable processing units.

In accordance with one embodiment, the mobile team processing unit further receives data from an additional sensor; further wherein the processing of the at least one corresponding individual functional assessment is performed using the data received from the additional sensor.

In accordance with one embodiment, the system further comprises an external client operatively connected to each of the at least one mobile individual processing unit, the external client receiving each corresponding individual functional assessment from each of the at least one mobile individual processing unit.

In accordance with one embodiment, the external client is selected from a group consisting of desktop computers, portable computers, servers and smartphones.

In accordance with one embodiment, the plurality of sensors are selected from a group consisting of wearable sensors and non-wearable sensors.

In accordance with one embodiment, the wearable sensors are selected from a group consisting of electrocardiogram sensors, accelerometer sensors, breathing sensors and eye-tracking sensors.

In accordance with one embodiment, the non-wearable sensors are selected from a group consisting of eye-tracking systems and seat integrated sensors.

In accordance with a broad aspect, there is disclosed a method for providing data representative of an individual functional assessment of a user for determining team-level metrics data of a team comprising the user and at least one other user, the method comprising collecting sensor data originating from a plurality of sensors, processing the collected sensor data to provide data representative of an individual functional assessment and wirelessly transmitting the data representative of an individual functional assessment to a processing unit capable of processing the obtained data representative of an individual functional assessment as well as other obtained data representative of the at least one other user individual functional assessment to generate data representative of a team functional assessment.

In accordance with a broad aspect, there is disclosed a non-transitory computer-readable storage medium for storing computer-executable instructions which, when executed, cause a processing unit to perform a method for providing data representative of an individual functional assessment of a user for determining team-level metrics data of a team comprising the user and at least one other user, the method comprising collecting sensor data originating from a plurality of sensors; processing the collected sensor data to provide data representative of an individual functional assessment; wirelessly transmitting the data representative of an individual functional assessment to a processing unit capable of processing the obtained data representative of an individual functional assessment as well as other obtained data representative of the at least one other user individual functional assessment to generate data representative of a team functional assessment.

In accordance with an embodiment, the data representative of a team functional assessment is provided in near real time.

An advantage of the system for monitoring a functional state of a team disclosed herein is that the application runs locally on a mobile individual processing unit and uses wearable sensor data to produce team-level metrics data which are produced in near real time during the course of an activity.

Another advantage of the system for monitoring a functional state of a team disclosed herein is that team-level metrics are not merely aggregations of individual metrics values such as averages or sums. They are properties that emerge through team interaction. Sensor data and metrics associated with individual team members are read and team-level metrics are calculated.

An advantage of the system for monitoring a functional state of a team disclosed herein is that a team functional assessment may be determined. The system performs a set of analyses to derive the team-level metrics based on predefined routines; it reads the data stream to access variable values, calculates current values for each metrics and send these values as an output to either a graphical user interface, a team-level metrics log file, or directly to another application, such as a geographic information system, for instance. The output may then be used in various ways, such as being displayed to team members and supervisors to support coordination processes and team management processes. The output may also be logged and used for ulterior analysis, or serve as input for other applications.

An advantage of the method disclosed herein is that it provides the capability for handling near-real-time team diagnostics, creating new possibilities for data collection on human factors, team management, team feedback during training and for safety monitoring.

### BRIEF DESCRIPTION OF THE DRAWINGS

In order that the invention may be readily understood, embodiments of the invention are illustrated by way of example in the accompanying drawings.

FIG. 1 is a flowchart which shows an embodiment of a method for providing team-level metrics data. According to a first step, sensor data is collected from a plurality of sensors. According to a second step, the collected sensor data is locally processed to provide data representative of an individual functional assessment. According to a third step, each of the data representative of an individual functional assessment is wirelessly obtained. According to a fourth step, each of the obtained data representative of an individual functional assessment is processed to generate data representative of a team functional assessment.

FIG. 2 is a flowchart which shows an embodiment for collecting sensor data from a plurality of sensors.

FIG. 3 is a flowchart which shows an embodiment for locally processing the collected sensor data to provide data representative of an individual functional assessment.

FIG. 4 is a flowchart which shows an embodiment for wirelessly obtaining each of the data representative of an individual functional assessment.

FIG. 5 is a flowchart which shows an embodiment for processing each of the obtained data representative of an individual functional assessment.

FIG. 6 is a block diagram which shows an embodiment of a system for providing team-level metrics data.

FIG. 7 is a diagram which shows an embodiment for generating of a feature.

FIG. 8 shows an embodiment of an algorithm for determining a dimension.

FIGS. 9A and 9B are diagrams which show an embodiment of the system disclosed in FIG. 7.

Further details of the invention and its advantages will be apparent from the detailed description included below.

### DETAILED DESCRIPTION

In the following description of the embodiments, references to the accompanying drawings are by way of illustration of an example by which the invention may be practiced.

### Terms

The term “invention” and the like mean “the one or more inventions disclosed in this application,” unless expressly specified otherwise.

The terms “an aspect,” “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not all) embodiments of the disclosed invention(s),” unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including,” “comprising” and variations thereof mean “including but not limited to,” unless expressly specified otherwise.

The terms “a,” “an” and “the” mean “one or more,” unless expressly specified otherwise.

The term “plurality” means “two or more,” unless expressly specified otherwise.

The term “herein” means “in the present application, including anything which may be incorporated by reference,” unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example,” and thus do not limit the terms or phrases they explain. For example, in a sentence “the computer sends data (e.g., instructions, a data structure) over the Internet,” the term “e.g.” explains that “instructions” are an example of “data” that the computer may send over the Internet, and also explains that “a data structure” is an example of “data” that the computer may send over the Internet. However, both “instructions” and “a data structure” are merely examples of “data,” and other things besides “instructions” and “a data structure” can be “data.”

The term “i.e.” and like terms mean “that is,” and thus limit the terms or phrases they explain.

The term “team-level metrics data” and like terms mean quantitative data characterizing team state and processes. For instance the team-level metrics data may comprise, for instance, workload balance, centrality, closeness centrality, degree centrality, network density, distance and reciprocity.

The term “team functional assessment” and like terms mean information that may be used for assessing a functional state of a team. For instance, the team functional state refers to the current ability of a team to carry out its task(s) in a nominal fashion.

The term “individual functional assessment” and like terms mean the multi-determined psychophysiological conditions that mediate the ability of an individual to carry out his/her task(s) in a nominal fashion.

The term “feature” and like terms mean data vectors processed in a certain way so that the signal to noise ratio is optimized.

The term “dimension data” and like terms mean data related to mediating states that qualify the state of an individual or a team. For instance, the dimension data comprise data related to fatigue, mental workload, stress, tunnel vision, engagement and alertness.

Neither the Title nor the Abstract is to be taken as limiting in any way as the scope of the disclosed invention(s). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

With all this in mind, the present invention is directed to a method and a system for providing team-level metrics data.

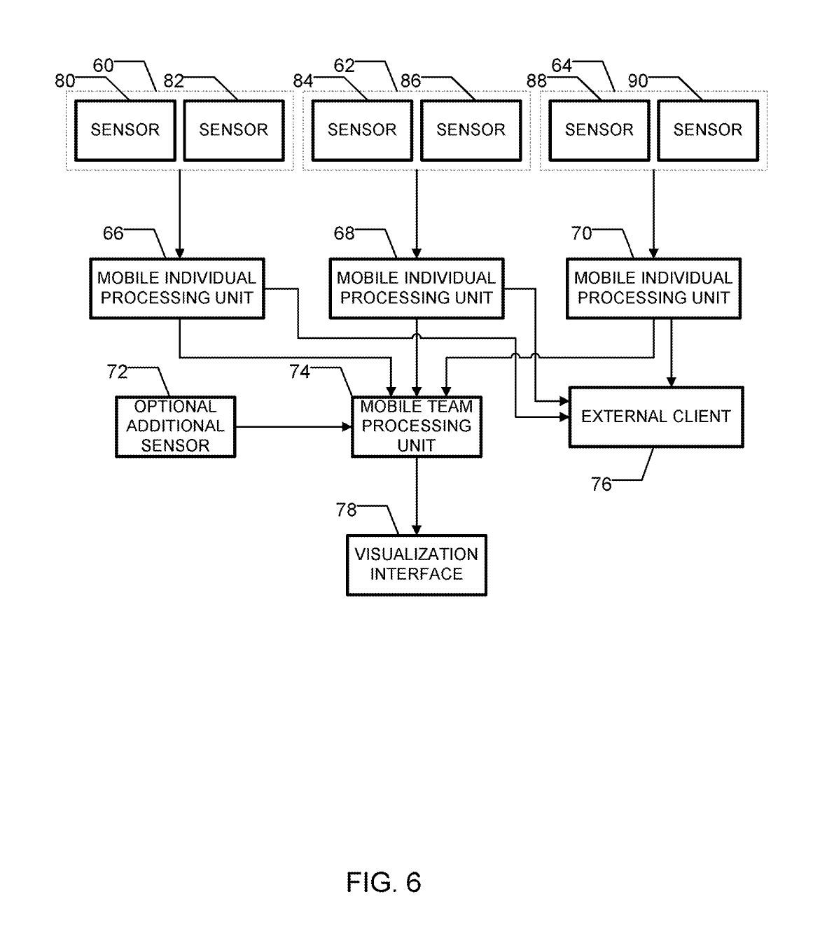

Now referring to FIG. 6, there is shown an embodiment of a system for providing team-level metrics data.

In this embodiment, the system comprises a first plurality of sensors 60, a second plurality of sensors 62, and a third plurality of sensors 64. While there is shown an embodiment with three pluralities of sensors, it will be appreciated by the skilled addressee that any number of pluralities of sensors may be provided.

More precisely, the first plurality of sensors 60 comprises sensor 80 and sensor 82, while the second plurality of sensors 62 comprises sensor 84 and sensor 86. The third plurality of sensors 64 comprises sensor 88 and sensor 90.

While there has been disclosed an embodiment wherein each of the pluralities of sensors comprises two sensors, it will be again appreciated by the skilled addressee that any number of sensors may be provided in each of the pluralities of sensors.

It will be also appreciated that the sensors may be selected from a group consisting of wearable sensors and non-wearable sensors. A wearable sensor is worn by a user. In one embodiment, the wearable sensors are selected from a group consisting of an electrocardiogram sensors, accelerometer sensors, breathing sensors, and eye-tracking sensors. It will be appreciated that in one embodiment the electrocardiogram sensor, the accelerometer sensor and the breathing sensor may be integrated in a chest strap. Still in one embodiment, the eye-tracking sensor is embedded in wearable glasses. In one non-limiting example, the sampling rate of the electrocardiogram sensor is is 500 Hz, the sampling rate of the breathing sensor is 56 Hz, the sampling rate of the accelerometer sensor is 250 Hz and the eye-tracking samples is 30 Hz. Still in one embodiment, the eye-tracking sensor transmits data through Wifi, while data originating from the other sensors is transmitted via Bluetooth™. Still in one embodiment, the electrocardiogram sensor is a single lead ECG, while the breathing sensor uses the respiratory inductance plethysmography technique and the eye-tracking sensor uses the infrared corneal reflection technology. The skilled addressee will appreciate that various alternative embodiments may be possible.

Non-wearable sensors, may be selected from a group consisting of eye-tracking systems, seat integrated sensors such as ECG, thermometers and breathing sensors.

Still referring to FIG. 6, the system further comprises a first mobile individual processing unity 66, a second mobile individual processing unit 68 and a third mobile individual processing unit 70.

In this particular embodiment, the first mobile individual processing unit 66 is operatively connected to the first plurality of sensors 60, while the second mobile individual processing unit 68 is operatively connected to the second plurality of sensors 62. The third mobile individual processing unit 70 is operatively connected to the third plurality of sensors 64.

In one embodiment, the first mobile individual processing unit 66 is operatively connected to the first plurality of sensors 60 using a wireless connection such as Bluetooth™. It will be appreciated that various alternative embodiments may be possible such as, for instance, embodiments in which other wireless communication protocols are used or other embodiments in which a wired connection is used between a mobile individual processing unit and a corresponding plurality of sensors.

It will be appreciated that each of the first mobile individual processing unit 66, the second mobile individual processing unit 68 and the third mobile individual processing unit 70 is carried by a given user of a team.

In fact, each of the first mobile individual processing unit 66, the second mobile individual processing unit 68 and the third mobile individual processing unit 70 is capable of receiving corresponding sensor data originating respectively from each of the first plurality of sensors 60, the second plurality of sensors 62 and the third plurality of sensors 64, and of generating and providing a corresponding signal indicative of a corresponding individual functional assessment.

It will be appreciated that the processing performed in each of the first mobile individual processing unit 66, the second mobile individual processing unit 68 and the third mobile individual processing unit 70 is performed independently from one another. In other terms, each of the first mobile individual processing unit 66, the second mobile individual processing unit 68 and the third mobile individual processing unit 70 is autonomous.

The first mobile individual processing unit 66, the second mobile individual processing unit 68 and the third mobile individual processing unit 70 may be selected from a group consisting of smartphones, tablet PCs and dedicated portable processing units. In one embodiment, each of the first mobile individual processing unit 66, the second mobile individual processing unit 68 and the third mobile individual processing unit 70 is a smartphone running one of iOS™, Windows™ and Android™ operating systems.

Still referring to FIG. 6, it will be appreciated that the system further comprises an external client 76. The external client 76 may be selected from a group consisting of desktop computers, portable computers, servers, smartphones, etc.

More precisely, each of the first mobile individual processing unit 66, the second mobile individual processing unit 68 and the third mobile individual processing unit 70 is operatively connected to the external client 76 and is capable of transmitting corresponding individual functional assessment data to the external client 76 as further explained below. In one embodiment, each of the first mobile individual processing unit 66, the second mobile individual processing unit 68 and the third mobile individual processing unit 70 is operatively connected to the external client 76 via a wireless data network, not shown. The skilled addressee will appreciate that the wireless data network may be of various types.

Still referring to FIG. 6, it will be appreciated that the system further comprises a mobile team processing unit 74.

The mobile team processing unit 74 is operatively connected to the first mobile individual processing unit 66, to the second mobile individual processing unit 68 and to the third mobile individual processing unit 70. The mobile team processing unit 74 is further connected to an optional additional sensor 72.

The mobile team processing unit 74 is used for receiving and processing corresponding individual functional assessment data originating from respectively each of the first mobile individual processing unit 66, the second mobile individual processing unit 68, from the third mobile individual processing unit 70 as well as data originating from an optional additional sensor 72.

It will be appreciated that the optional additional sensor 72 may be of various types. In one embodiment, the optional additional sensor 72 is selected from a group consisting of thermometers, GPS tracking information, and vehicle data. This type of sensors could provide data, for instance, about the location of a support vehicle relative to the team members, and consequently inform about the capacity of the team to carry out its tasks.

It will be appreciated that the mobile team processing unit 74 may be of various types. In one embodiment, the mobile team processing unit 74 is selected from a group consisting of smartphones, tablet PCs and dedicated portable processing units. In one embodiment, the mobile team processing unit 74 is a smartphone running one of iOS™ and Android™ operating systems.

Still in one embodiment, it will be appreciated that the mobile team processing unit 74 is one of the first mobile individual processing unit 66, the second mobile individual processing unit 68 and the third mobile individual processing unit 70.

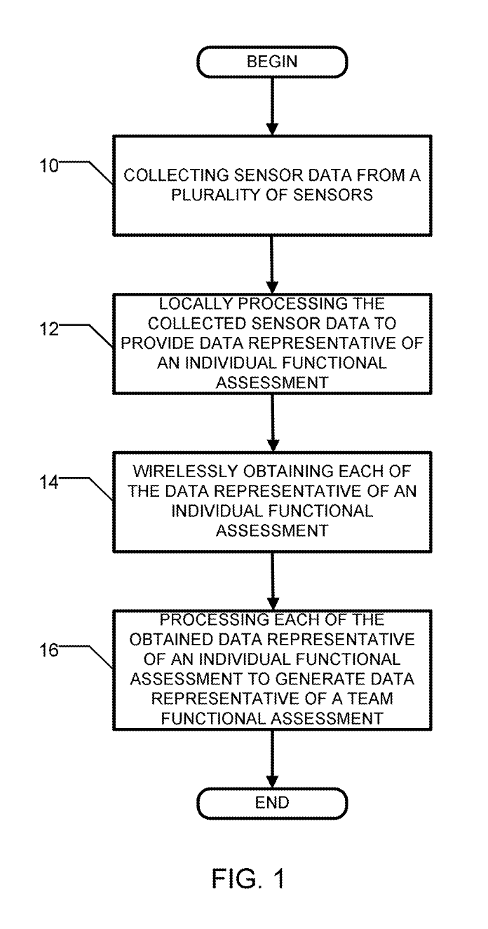

Now referring to FIG. 1, there is shown an embodiment of a method for providing team-level metrics data.

According to processing step 10, sensor data is collected from a plurality of sensors.

It will be appreciated that the collecting of the sensor data may be performed according to various embodiments.

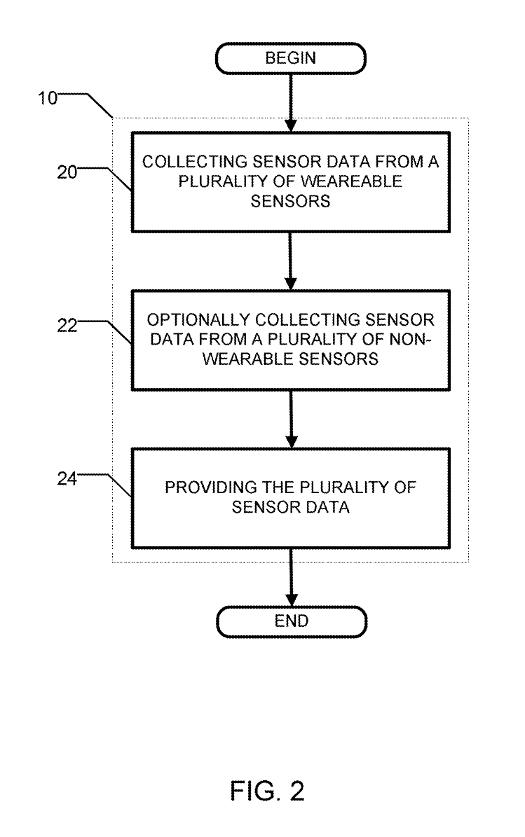

Now referring to FIG. 2, there is an embodiment for collecting the sensor data.

According to processing step 20, sensor data is collected from a plurality of wearable sensors. It will be appreciated that the wearable sensors may be of various types as mentioned above.

According to processing step 22, sensor data originating from a plurality of non-wearable sensors is optionally collected. It will be appreciated that the non-wearable sensors may be of various types as mentioned above.

According to processing step 24, the plurality of sensor data is provided.

Now referring back to FIG. 1 and according to processing step 12, the collected sensor data is locally processed to provide data representative of an individual functional assessment.

It will be appreciated that the processing of the collected sensor data performed in order to provide data representative of an individual functional assessment may be performed according to various embodiments.

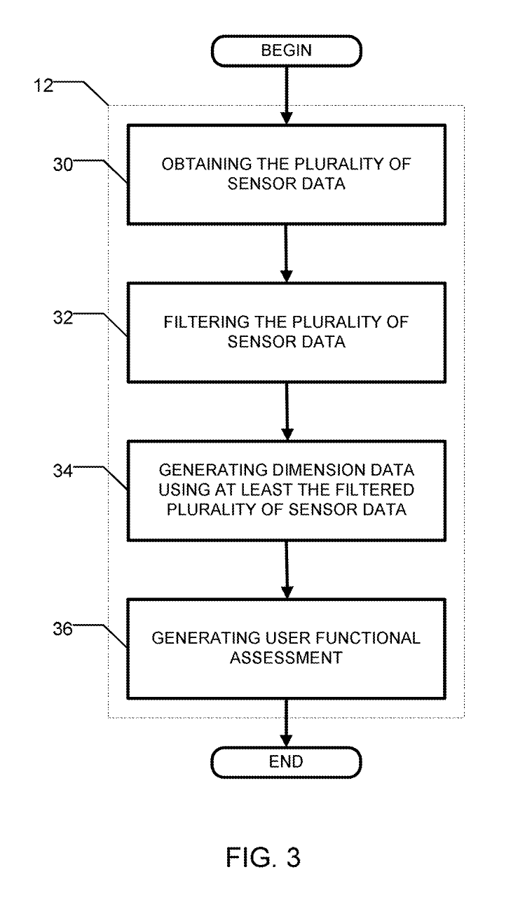

Referring to FIG. 3, there is shown an embodiment for processing the collected sensor data to provide data representative of an individual functional assessment.

According to processing step 30, the plurality of sensor data is obtained.

In one embodiment, the plurality of sensor data is obtained from an eye tracker, an electrocardiogram sensor and a breathing sensor.

According to processing step 32, the plurality of sensor data is filtered.

It will be appreciated that the purpose of the filtering is to provide what is referred to as features. Features are data vectors processed in a certain way so that the signal-to-noise ratio is optimized. In one embodiment, the filtering is performed using at least one of Fast Fourrier Transform (FFT) procedures, moving average and Kalman filters. It will be further appreciated that in one embodiment data originating from multiple sensors may be combined to generate the features.

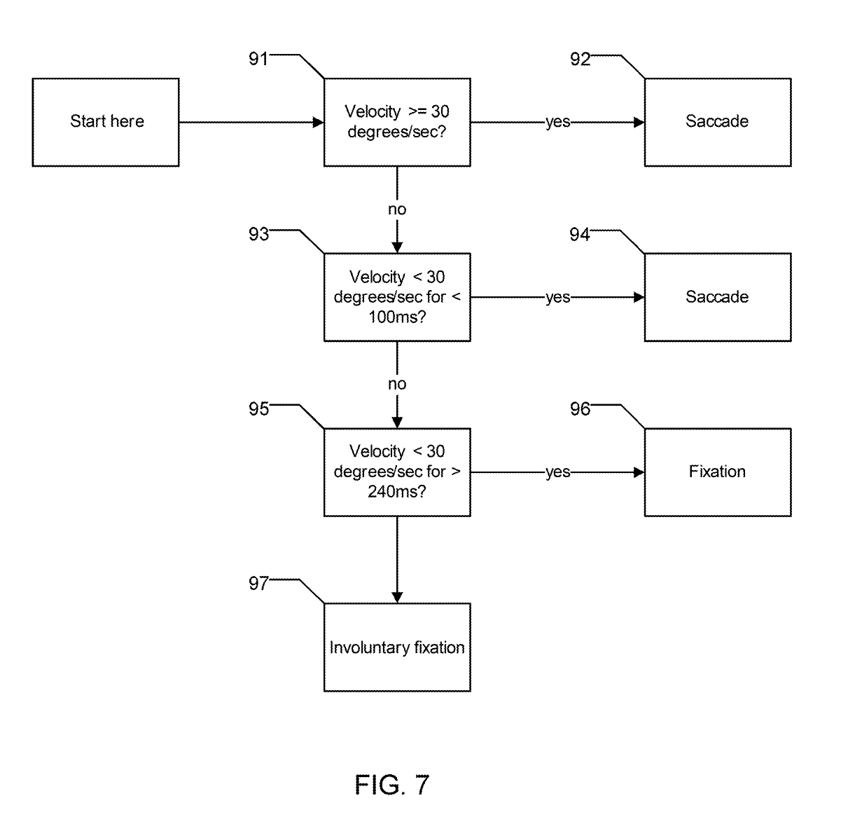

Now referring to FIG. 7, there is shown an embodiment of a decision tree for classifying the state of the eye of the user using an eye tracker sensor. Still in this embodiment, the data provided by the eye tracker sensor include the “scene” x and y position of the gaze of the user. Such information is transformed into features by, inter alia, calculating the velocity of the eye and classifying the state of the eye into one of saccade, fixation and involuntary fixation.

At state 91, a test is performed in order to find out if the velocity of the eye of the user is greater than or equal to 30 degrees/sec.

In the case where the velocity of the eye is greater than or equal to 30 degrees/sec, the state of the eye of the user is classified to be in a saccade, referred to as state 92 in FIG. 7.

In the case where the velocity of the eye is not greater than 30 degrees/sec and according to state 93, a test is performed to find out if the velocity is smaller than 30 degrees/sec for a duration of less than 100 ms.

In the case where the velocity is smaller than 30 degrees/sec for a duration of less than 100 ms, the state of the eye of the user is classified to be in a saccade, referred to as state 94 in FIG. 7.

In the case where the velocity of the eye of the user is not smaller than 30 degrees/sec for a duration of less than 100 ms and according to state 95, a test is performed to find out if the velocity is smaller than 30 degrees/sec for more than 240 ms. In the case where the velocity is smaller than 30 degrees/sec for more than 240 ms, the state of the eye of the user is classified to be in fixation, referred to as state 96 in FIG. 7.

In the case where the velocity is not smaller than 30 degrees/sec for more than 240 ms, the state of the eye of the user is classified to be in an involuntary fixation, referred to as state 97 in FIG. 7. The skilled addressee will appreciate that various alternative embodiments may be used to extract features from the eye tracker sensor.

In the case of the heart rate sensor, the variance of the RR interval (SDNN) may be computed. It is mathematically equal to the total power of spectral analysis. Consequently, this feature reflects both short-term and long-term variations within the RR interval durations.

$$SDNN = \sqrt{\frac{1}{N - 1} {\sum }_{j = 1}^{N} {( {RR}_{j} - \overline{RR} )}^{2}}$$

It will be appreciated that the SDNN is static, meaning that it is computed for a complete temporal series of RR durations. Moreover, it is known to increase with an increase of the total duration of the recording, therefore invalidating comparisons between different lengths of recordings. For this reason the SDANN should be preferred. It is basically the same metric, but calculated over a time window of N minutes, typically 5.

According to processing step 34, dimensions data are generated using at least the plurality of filtered sensor data.

It will be appreciated that dimensions data are referred to as mediating states that qualify the state of an individual or a team. For instance, at the individual level, dimensions include, but are not limited to, mental workload, stress, fatigue, physical stress and tunnel vision.

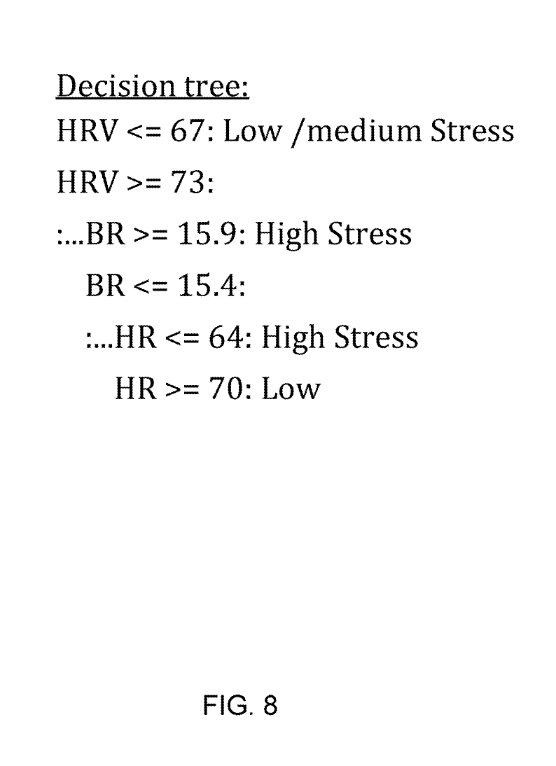

Now referring to FIG. 8, there is shown an embodiment of a decision tree for determining a stress level of a user.

In the case where the heart rate value (HRV) is smaller than or equal to 67, the stress level of the user is referred to as low/medium.

In the case where the heart rate value (HRV) is greater than or equal to 73, a test is performed in order to find out if the breathing rate is greater or equal to 15.9. If this is the case, the stress level of the user is referred to as high.

In the case where the breathing rate is smaller than or equal to 15.4, a test is performed in order to find out if the heart rate value is smaller than or equal to 64. If this is the case, the stress level of the user is referred to as high.

In the case where the breathing rate is greater or equal to 70, the stress level of the user is referred to as low stress.

For computing the tunnel vision dimension, the formula Z=(x−u)/sd may be used, wherein:
x=proportion of fixation (short) (mean over 10 seconds);
u=proportion of fixation (long) (mean over 300 seconds);
sd=standard deviation of proportion of fixation (short) over the last 300 seconds.

It will be appreciated that the model compares the actual ocular behavior of the operator with a dynamic criterion based on the recent own behavior. It returns a standardized deviation of the actual behavior, i.e., last 10 seconds, compared to the recent behavior, i.e., last 5 minutes. The z score will tell if the user is currently fixating more in the last 10 seconds in comparison to the last 5 minutes. It will also give an indication of the amplitude of the difference. The amplitude of the deviation is an indication of how much the behavior is different from recent history and could consequently be used as a warning.

According to processing step 36, the user functional assessment is generated.

It will be appreciated that the user functional assessment is an interpreter of the dimensions to provide an overall “bigger picture” of the capability of the user to carry out a required task.

In one embodiment, the user functional assessment is generated using the dimension data.

For instance and in one embodiment, the user functional assessment may be referred as one of red, orange and green.

In this embodiment, a red user functional assessment means that the operator is currently at high risk of committing errors while carrying out his task(s) while an orange user functional assessment means that the operator as an increased risk of committing errors while carrying out his task(s) and a green user functional assessment means that the operator is at low risk of committing errors while carrying out his tasks.

To determine the user functional assessment, the following test may be performed.

According to a first step, a test is performed in order to find out if the stress value computed earlier is defined as high and the product of the absolute value of Z is greater than 2.5. If this is the case, the user functional assessment is classified as red.

If this is not the case and either the stress value computed earlier is defined as high or the product of the absolute value of Z is greater than 2.5, then the user functional assessment is classified as orange.

If this is not the case, the user functional assessment is classified as green.

The skilled addressee will appreciate that the test provided above for determining the user functional assessment is just an embodiment and that many alternative embodiments may be created depending on various criteria such as the sensors available, a task to be achieved by an operator, a type of individual, etc.

Now referring back to FIG. 1 and according to processing step 14, each of the data representative of a user functional assessment is wirelessly obtained.

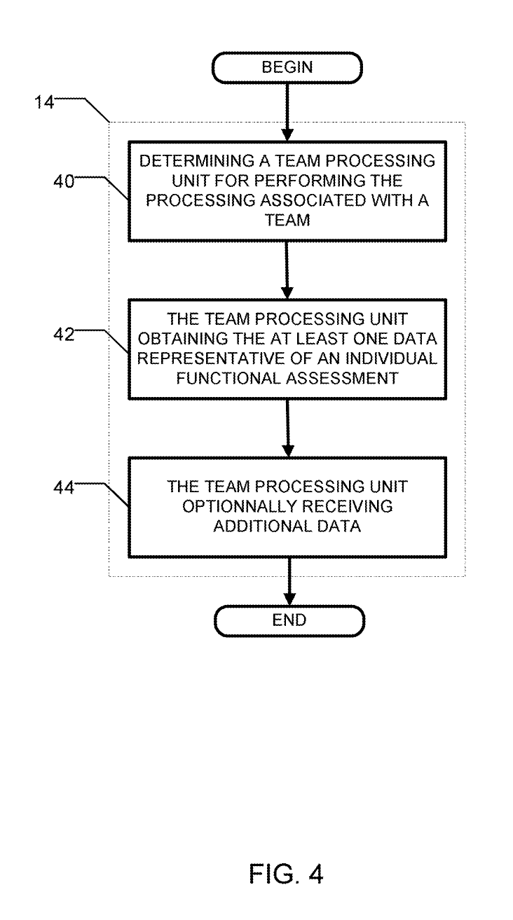

Now referring to FIG. 4, there is shown an embodiment for wirelessly obtaining each of the data representative of a user functional assessment.

According to processing step 40, a team processing unit is identified for performing the processing associated with a given team comprising a plurality of users.

In fact, it will be appreciated that the team processing unit may be any one of the plurality of mobile individual processing units as explained above in one embodiment.

According to processing step 42, the team processing unit obtains at least one datum representative of a user functional assessment.

According to processing step 44, the team processing unit optionally receives additional data. It will be appreciated that the additional data may be obtained from other data sources.

For instance, the additional data may comprise additional data pertaining to the structure of a team.

In one embodiment, the additional data may be obtained from the optional additional sensor 72 shown in FIG. 6.

Now referring back to FIG. 1 and according to processing step 16, each of the obtained data representative of a user functional assessment is processed in order to generate data representative of team functional assessment. It will be appreciated that the processing may be performed according to various embodiments.

It will be appreciated that the team functional assessment provides an overall bigger picture of the capability of a team to carry out a given task.

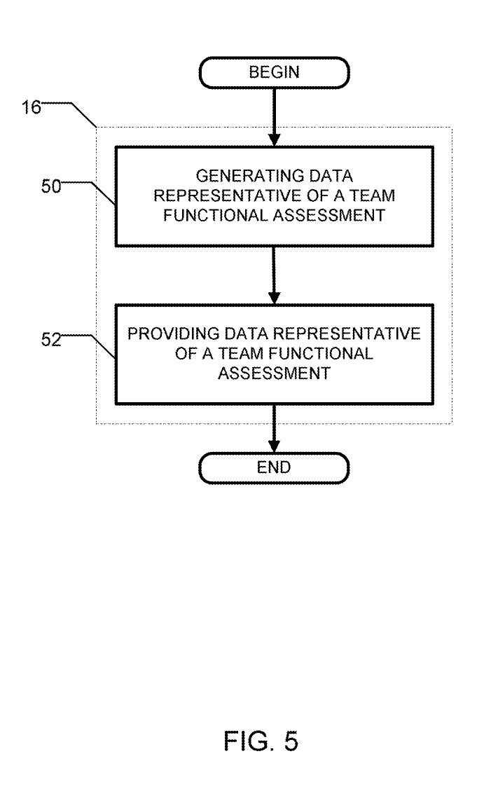

Now referring to FIG. 5, there is shown an embodiment for processing each of the obtained data representative of a user functional assessment to generate data representative of a team functional assessment.

According to step 50, data representative of a team functional assessment is generated.

It will be appreciated that the generating of the data representative of a team functional assessment may be performed according to various embodiments.

According to processing step 52, data representative of a team functional assessment is provided. It will be appreciated that the data representative of a team functional assessment may be provided according to various embodiments.

In one embodiment, the data representative of a team functional assessment is provided to the visualization interface 78 shown in FIG. 6.

The skilled addressee will appreciate that the providing of the data representative of a team functional assessment may be performed according to various embodiments.

For instance and in one embodiment, the data representative of a team functional assessment may be pushed to the visualization interface 78 by the mobile team processing unit.

In an alternative embodiment, the data representative of a team functional assessment may be pulled from the mobile team processing unit 74 by the visualization interface.

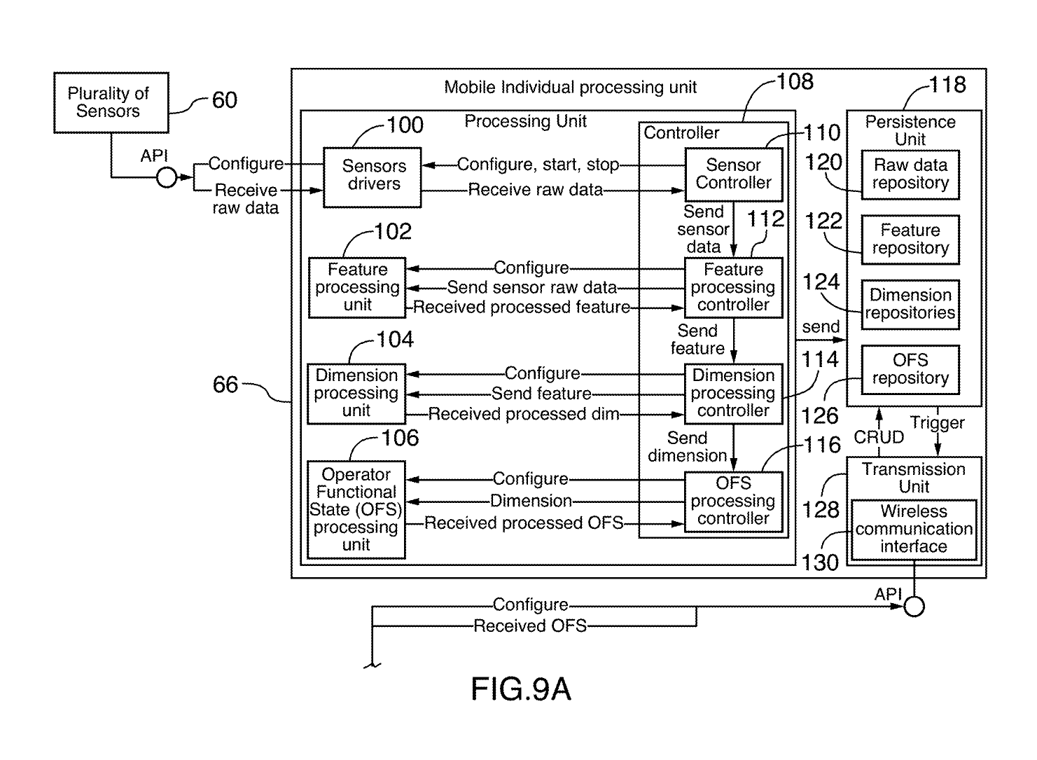

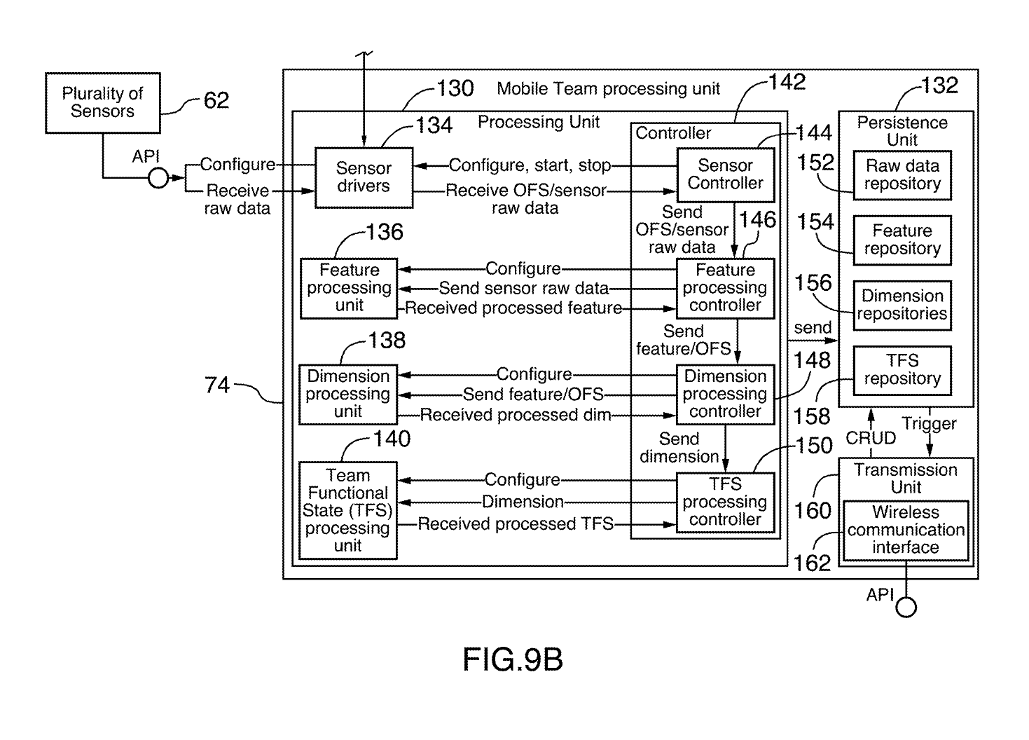

Now referring to FIG. 9a, there is shown an embodiment of the first mobile individual processing unit 66.

As shown in FIG. 9a, the first mobile individual processing unit 66 is operatively connected to the first plurality of sensors 60.

The first mobile individual processing unit 66 comprises, inter alia, a processing unit, a persistence unit 118 and a transmission unit 128.

The processing unit comprises sensor drivers 100, a feature processing unit 102, a dimension processing unit 104, and an operator functional state processing unit 106.

The processing unit further comprises a controller 108 comprising a sensor controller 110, a feature processing controller 112, a dimension processing controller 114 and an operator functional state processing controller 116.

The sensor drivers 100 are capable of configuring the plurality of sensors 60 and of obtaining raw data. Therefore, the skilled addressee will appreciate that the sensor drivers 100 depend on the type of sensors of the first plurality of sensors 60. In one embodiment, the sensor drivers 100 are capable of driving an eye-tracking system and a chest strap with electrocardiogram, accelerometers and breathing sensors. It will be appreciated that the raw data provided by the sensor drivers is time-stamped for alignment purposes.

The sensor controller 110 is capable of configuring, starting, stopping the sensor drivers 100 and of obtaining raw data from the sensor drivers 100.

The sensor controller 110 is further capable of sending the sensor data to the feature processing controller 112 of the controller 108.

The feature processing controller 112 is capable of configuring and sending sensor raw data to the feature processing unit 102. The feature processing controller 112 receives processed features from the feature processing unit 102.

It will be appreciated that the features are data vectors processed so that the signal-to-noise ratio is optimized, as mentioned above.

The feature processing controller 112 provides the features to a dimension processing controller 114. The dimension processing controller 114 is capable of configuring and sending the features to a dimension processing unit 104. The dimension processing unit 104 provides a processed dimension to the dimension processing controller 114 in return. The dimension processing controller 114 provides the dimension to an operator functional state processing controller 116. The operator functional state processing controller 116 is capable of configuring and sending the dimension to an operator functional state processing unit 106. The operator functional state processing controller 116 is capable of receiving processed operator functional state from the operator functional state processing unit 106. The processing unit is capable of sending data to the persistence unit 118. It will be appreciated that the persistence unit 118 comprises a raw data repository 120, a feature repository 122, a dimension repository 124 and an operator functional state repository 126.

The persistence unit 118 is capable of triggering the transmission unit 128, which comprises the wireless communication interface 130. In response, the first mobile individual processing unit 66 may send to the mobile team processing unit 74 data associated with the user functional assessment.

The mobile team processing unit 74 comprises a processing unit 130, a persistence unit 132 and a transmission unit 160.

More precisely, the processing unit 130 comprises sensor drivers 134, feature processing unit 136, dimension processing unit 138, team functional state processing unit 140, and the controller 142.

The controller 142 comprises a sensor controller 144, a feature processing controller 146, a dimension processing controller 148 and a team functional state processing controller 150.

The persistence unit 132 comprises a raw data repository 152, a feature repository 154, a dimension repository 156 and a team functional state repository 158.

The transmission unit 160 comprises a wireless communication interface 162.

The sensor drivers 134 of the processing unit 130 receive the data indicative of a user functional assessment, as well as raw data provided by device sensor 62.

The sensor drivers 134 are capable of configuring the device sensor 62. The sensor controller 144 is capable of configuring, starting and stopping the sensor drivers 134. The sensor controller 144 is further capable of receiving the data indicative of a user functional assessment/sensor raw data from the sensor drivers 134.

The sensor controller 144 is further capable of sending the data indicative of a user functional assessment/sensor raw data to the feature processing controller 146. The feature processing controller 146 is capable of configuring and sending sensor raw data to a feature processing unit 136. The feature processing controller 146 is further capable of receiving processed features from the feature processing unit 136. The feature processing controller 146 is capable of sending the features and the user functional assessment to a dimension processing controller 148.

The dimension processing controller 148 is capable of configuring the dimension processing unit 138 and of sending features/user functional assessment to the dimension processing unit 138.

The dimension processing controller 148 is further capable of receiving processed dimensions from the dimension processing unit 138.

The dimension processing controller 148 is capable of sending a dimension to the team functional state processing controller 150.

The team functional state processing controller 150 is capable of configuring and sending dimensions to a team functional state processing unit 140.

The team functional state processing controller 150 is capable of receiving processed team functional assessment from the team functional state processing unit 140. It will be appreciated that the team functional assessment may then be transmitted to a remote location using the transmission unit 160, and more particularly the wireless communication interface 162.

It will be appreciated that the method and system disclosed herein may be used in applications where teams are involved, particularly where human errors may lead to serious consequences. Such domains may comprise, for instance and among others, aviation, public safety, emergency response and management, defense and security, and health care.

As explained further below, it will be appreciated that the method disclosed herein enables the capability to provide near-real-time diagnostics, creating possibilities for data collection on human factors, team management, team feedback during training and for safety monitoring. Team or team managers are provided with additional information in real time about the functional state of the team, which is its capability to carry out its tasks without error, or in an effective manner. Because an individual functional assessment is carried out, other fields of use also comprise work domain where individual work is performed. For instance, the method disclosed herein may be used in the transportation domain.

It will be appreciated that an advantage of the system disclosed herein is that it is modular. Such modularity is of great interest since it provides different levels of processing that all have value depending on the context. Moreover, the modular aspect of the processing enables a quick integration or modification of the system including components such as features, dimensions, or functional state definitions.

In addition, it will be appreciated that the members of a team may be distributed geographically.

Moreover, it will be appreciated that the members of a team are on the move and may not be wired.

It will be appreciated that the method disclosed herein is scalable since only necessary information/data is transmitted to upper level of processing.

It will be appreciated that a non-transitory computer-readable storage medium is further disclosed. The non-transitory computer-readable storage medium stores computer-executable instructions which, when executed, cause a processing unit to perform a method for providing data representative of an individual functional assessment of a user for determining team-level metrics data of a team comprising the user and at least one other user, the method comprising collecting sensor data originating from a plurality of sensors; processing the collected sensor data to provide data representative of an individual functional assessment; wirelessly transmitting the data representative of an individual functional assessment to a processing unit capable of processing the obtained data representative of an individual functional assessment as well as other obtained data representative of the at least one other user individual functional assessment to generate data representative of a team functional assessment.

Although the above description relates to a specific preferred embodiment as presently contemplated by the inventor, it will be understood that the invention in its broad aspect includes functional equivalents of the elements described herein.

1. A method for providing team-level metrics data, the method comprising:
for each member of a team:
collecting sensor data originating from a plurality of sensors, and
locally processing the collected sensor data to provide data representative of an individual functional assessment;
wirelessly obtaining each of the data representative of an individual functional assessment; and
processing each of the obtained data representative of an individual functional assessment to generate data representative of a team functional assessment.

2. The method as claimed in claim 1, wherein the processing comprises providing the data representative of a team functional assessment to a visualization interface.

3. The method as claimed in claim 2, wherein the providing of the data of a team functional assessment to a visualization interface comprises one of pushing and pulling the data of a team functional assessment to the visualization interface.

4. The method as claimed in claim 1, wherein the collecting of the sensor data originating from a plurality of sensors comprises collecting data from a plurality of wearable sensors and connecting data from a plurality of non-wearable sensors.

5. The method as claimed in claim 1, wherein the processing of the collected sensor data comprises filtering the collected sensor data, generating dimension data using at least the filtered collected sensor data and generating data representative of an individual functional assessment using the generated dimension data.

6. The method as claimed in claim 5, wherein the filtering of the collected sensor data is performed using at least one of a Fast Fourier Transform procedure, moving average and Kalman filters.

7. The method as claimed in claim 1, wherein the wirelessly obtaining of each of the data representative of an individual functional assessment comprises determining a team processing unit for performing the processing associated with the team and the team processing unit receiving each of the data representative of an individual functional assessment.

8. The method as claimed in claim 1, wherein the team processing unit further receives sensor data from at least one other sensor, further wherein the processing of each of the obtained data representative of an individual functional assessment to generate data representative of a team functional assessment is also performed using the sensor data received from the at least one other sensor.

9. The method as claimed in claim 1, further comprising providing the data representative of a team functional assessment to a remote processing unit.

10. A system for providing team-level metrics data of a team comprising a plurality of users, the system comprising:
a plurality of mobile processing units, the plurality of mobile processing units comprising:
at least one mobile individual processing unit, each carried out by a given user, each mobile individual processing unit receiving corresponding sensor data from a corresponding plurality of sensors, each mobile individual processing unit processing the corresponding sensor data and determining a corresponding individual functional assessment; and
a mobile team processing unit operatively connected to the at least one mobile individual processing unit, the mobile team processing unit receiving each of the at least one corresponding individual functional assessment and processing the at least one corresponding individual functional assessment to generate data representative of a team functional assessment.

11. The system as claimed in claim 10, wherein the mobile team processing unit is carried out by a given user of the team, further wherein the mobile team processing unit receives sensor data from a plurality of sensors operatively connected to the mobile team processing unit and processes the sensor data to determine an individual functional assessment for the given user; further wherein the generating of the data representative of a team functional assessment is performed using also the individual functional assessment for the given user.

12. The system as claimed in claim 10, wherein the plurality of mobile processing units are selected from a group consisting of smartphones, tablet PCs and dedicated portable processing units.

13. The system as claimed in claim 10, wherein the mobile team processing unit further receives data from an additional sensor; further wherein the processing of the at least one corresponding individual functional assessment is performed using the data received from the additional sensor.

14. The system as claimed in claim 10, further comprising an external client operatively connected to each of the at least one mobile individual processing unit, the external client receiving each corresponding individual functional assessment from each of the at least one mobile individual processing unit.

15. The system as claimed in claim 14, wherein the external client is selected from a group consisting of desktop computers, portable computers, servers and smartphones.

16. The system as claimed in claim 10, wherein the plurality of sensors are selected from a group consisting of wearable sensors and non-wearable sensors.

17. The system as claimed in claim 16, wherein the wearable sensors are selected from a group consisting of electrocardiogram sensors, accelerometer sensors, breathing sensors and eye-tracking sensors.

18. The system as claimed in claim 16, wherein the non-wearable sensors are selected from a group consisting of eye-tracking systems and seat integrated sensors.

19. A method for providing data representative of an individual functional assessment of a user for determining team-level metrics data of a team comprising the user and at least one other user, the method comprising:
collecting sensor data originating from a plurality of sensors;
processing the collected sensor data to provide data representative of an individual functional assessment; and
wirelessly transmitting the data representative of an individual functional assessment to a processing unit capable of processing the obtained data representative of an individual functional assessment as well as other obtained data representative of the at least one other user individual functional assessment to generate data representative of a team functional assessment.

20. A non-transitory computer-readable storage medium for storing computer-executable instructions which, when executed, cause a processing unit to perform a method for providing data representative of an individual functional assessment of a user for determining team-level metrics data of a team comprising the user and at least one other user, the method comprising collecting sensor data originating from a plurality of sensors; processing the collected sensor data to provide data representative of an individual functional assessment; wirelessly transmitting the data representative of an individual functional assessment to a processing unit capable of processing the obtained data representative of an individual functional assessment as well as other obtained data representative of the at least one other user individual functional assessment to generate data representative of a team functional assessment.

21. The method as claimed in claim 1, wherein the data representative of a team functional assessment is provided in near real time.
